(19) United States
(12) Patent Application Publication
(10) Pub. No.: US 2025/0036972 A1
(43) Pub. Date: Jan. 30, 2025

(54) METHOD FOR GENERATING A BEHAVIOR PREDICTION FOR A DEVICE, COMPUTER PROGRAM PRODUCT, COMPUTER-READABLE STORAGE MEDIUM AND ELECTRONIC COMPUTING DEVICE

(71) Applicant: Siemens Aktiengesellschaft, Munchen (DE)

(72) Inventors: Anja Hentschel, München (DE); Christian Hahn, Höchstadt a.d. Aisch (DE); Matthias Saft, Olching (DE)

(21) Appl. No.: 18/774,046

(22) Filed: Jul. 16, 2024

(30) Foreign Application Priority Data
Jul. 27, 2023 (EP) 23188145.9

(51) Int. Cl. G06N 5/022

(52) U.S. Cl. CPC G06N 5/022

(57) ABSTRACT

A method for generating a behavior prediction for a device by way of an electronic computing device is provided, including the following steps: providing an initial model of the device by way of the electronic computing device; recording at least one behavior parameter currently characterizing the device by way of a recording device of the electronic computing device; adapting the initial model, on the basis of the recorded behavior parameter, so as to form a behavioral model of the device by way of the electronic computing device; recording a simulation parameter for the device by way of a further recording device of the electronic computing device; assessing the behavioral model on the basis of the simulation parameter by way of the electronic computing device; and generating the behavior prediction on the basis of the evaluation by way of the electronic computing device. A computer program product, to a computer-readable storage medium and to an electronic computing device is also provided.

### CROSS-REFERENCE TO RELATED APPLICATIONS

This application claims priority to EP application Ser. No. 23/188,145.9, having a filing date of Jul. 27, 2023, the entire contents of which are hereby incorporated by reference.

### FIELD OF TECHNOLOGY

The following relates to a method for generating a behavior prediction for a device by way of an electronic computing device. The following relates to a computer program product, to a computer-readable storage medium and to an electronic computing device.

### BACKGROUND

Predictions regarding the expected behavior of an individual physical device, taking into account the history of this individual device, are already known. In embodiments at the beginning of the life cycle of a device, the expected behavior thereof is able to be predicted well using models. However, the use of physical devices, for example motors or engines, but also electronic components, causes their behavior to change over time, and the behavior deviates from that predicted by the model to an increasing extent as operating time goes on. The change in behavior is caused for example by external influences to which the device is inevitably exposed during operation. These influences are for example partly detectable influences, such as for example control inputs or certain environmental influences, such as for example temperature, air pressure or mechanical resistance, and partly also influences that cannot be detected or are able to be detected only with difficulty, such as for example wear or soiling. During the life cycle of a device, it is always necessary to make decisions about the use of this device. By way of example, a decision should be made, taking into account the actual state and the actual performance of the device, as to whether for example a device should be subjected to a maintenance operation or taken out of service, as to whether the device is still able to be used for a certain task, or as to which of multiple devices is best suited for a particular use. Since the above-described influences that have affected the device since the commissioning of the device are not able to be detected in full, such decisions have been able to be made up to now only with the aid of models, expert experience and assumptions. This type of decision-making is fraught with major uncertainties and entails significant risks, for example economic damage or risk to people. In order to limit these risks, safety margins are often set to be significantly higher than actually required in the prior art, and devices are repaired or replaced earlier than necessary.

### SUMMARY

An aspect relates to a method, a computer program product (non-transitory computer readable storage medium having instructions, which when executed by a processor, perform actions), a computer-readable storage medium and an electronic computing device by way of which it is possible to generate a reliable behavior prediction for a device.

One aspect of embodiments of the invention relates to a method for generating a behavior prediction for a device by way of an electronic computing device. An initial model of the behavior of the device is provided by way of the electronic computing device. At least one behavior parameter currently characterizing the device is recorded by way of a recording device of the electronic computing device. The initial model is adapted, on the basis of the recorded behavior parameter, so as to form a behavioral model of the device by way of the electronic computing device. A simulation parameter for the device is recorded by way of a further recording device of the electronic computing device. The behavioral model is evaluated on the basis of the simulation parameter by way of the electronic computing device, and the behavior prediction is generated on the basis of the evaluation by way of the electronic computing device.

In embodiments, the physical device may thus be complemented with a behavioral doppelganger. In embodiments during operation of the device, the behavioral doppelganger, which corresponds in particular to the behavioral model, learns the current behavior of the device. If external influences lead to a change in the behavior, the behavioral doppelganger adapts thereto with a short delay, in particular learns alongside. By way of example, the behavioral doppelganger is used for decision-making. Expected behavior of the device is predicted or simulated on the basis of the currently learned behavior.

The recording device may be for example a temperature sensor, voltage sensor, current sensor, speed measurement sensor or the like, which characterize and describe the device accordingly. The further recording device may be for example an input device, for example a keypad or the like, via which it is possible for a person to input a corresponding simulation parameter for simulating the device or training parameter for training the behavioral model. In embodiments, the simulation or the behavior prediction is thus performed under the conditions of the simulation parameter, which is specified for example by a person.

The behavioral model thus reflects only the behavior of the device, and thus does not represent a digital twin. Compared to the digital twin, the behavioral model has the advantage that it is able to work much more efficiently in terms of computation, since it is not necessary to simulate every function, like in the digital twin, but rather the behavior is modelled only on the basis of the existing model and the corresponding parameters. The behavioral model is thus a model independent of a digital twin. By way of example, a digital twin and the behavioral model may be formed in parallel for the device.

According to an embodiment, at least one behavior parameter is recorded continuously, and the behavioral model is adapted continuously. In other words, provision is made for the behavior parameter to be recorded continuously during operation of the device and for the behavioral model to accordingly be adapted continuously. It is thus accordingly possible to generate a behavior prediction for the device in a highly up-to-date and very precise manner.

It has also proved to be advantageous for the generated behavior prediction to be compared with an actual behavior of the device and for the behavioral model to be adapted on the basis of the comparison. Provision is thus made in particular for the behavioral doppelganger to constantly adapt to the actual behavior of the device, and thus learn alongside. This is achieved for example by measuring the observable or measurable influences and control inputs. Unobservable or unmeasurable influences that were previously lost for predictions are learned by the behavioral doppelganger through their effects. The doppelganger makes predictions regarding the expected response of the device to the corresponding inputs, which corresponds in particular to a predicted behavior. The actual responses of the device to these inputs are then observed and measured/recorded, as a result of which an actual behavior is recorded. The observed behavior results from the observable and measurable influences or inputs, the unobservable and unmeasurable influences, and also the current state of the device, for example the effects of all previous influences and inputs. A prediction quality is then determined by comparing the predicted and the actual behavior, which corresponds in particular to a prediction deviation. The behavioral doppelganger is then trained in turn by feeding back the prediction deviation. This makes it possible to generate a behavior prediction in a highly precise manner.

It has also proved to be advantageous for a control parameter for the device to be recorded as the simulation parameter. By way of example, corresponding currents or speeds may be specified and simulated for the device. Further influencing variables may also be replicated accordingly. A simulation or behavior prediction for the device is thus able to be generated on the basis of the control parameters.

It is also advantageous for an environmental parameter for the device to be recorded as the simulation parameter. By way of example, corresponding ambient temperatures, humidities or the like may be specified, these then in turn accordingly being able to be taken into account in the simulation, or a corresponding simulation or generation of the behavior prediction is able to be achieved on the basis of the specifications. It is thus possible to generate different responses of the behavioral model and make a precise prediction regarding the behavior.

A further embodiment makes provision for the electronic computing device to be provided with a neural network. In embodiments, the behavioral model may be trained or adapted on the basis of a neural network. Here and below, an artificial neural network may be understood as software code stored on a computer-readable storage medium and representing one or more networked artificial neurons or able to replicate the function thereof. The software code may in this case also contain multiple software code components, which may for example have different functions. In embodiments, an artificial neural network may implement a non-linear model or a non-linear algorithm that maps an input to an output, wherein the input is given by an input feature vector, or an input sequence and the output may for example contain a determined category for a classification task, one or more predicted values or a predicted sequence.

It is likewise advantageous for the neural network to be provided for reinforcement learning. Corresponding decisions of the neural network may in particular be fed back in the neural network. It is thus possible to implement feedback on the basis of the already generated decision, as a result of which it is possible to achieve extremely precise training of the behavioral model.

It has also proved to be advantageous for an actual behavior of the device to be recorded as behavior parameter. By way of example, actual speeds, voltages or currents may accordingly be recorded on the device. The actual behavior may then be used to adapt the behavioral model accordingly or to check the prediction quality of the behavioral model. This makes it possible to train the behavioral model in a highly precise manner.

It has also proved to be advantageous for current environmental conditions to be recorded at the device and taken into account when adapting the behavioral model. By way of example, humidity, temperature, light irradiation or the like may accordingly be recorded as environmental conditions. These environmental conditions are then taken into account when adapting the behavioral model, such that the behavioral model is accordingly able to be adapted in a highly precise manner.

It is likewise advantageous for a usability of the device for a specific intended purpose to be assessed on the basis of the behavior prediction. By way of example, it may be assessed whether the device is suitable for the specific use. By way of example, the simulation parameter may be used to specify appropriate specifications for the intended purpose. On the basis of these specifications, it may in turn be checked whether the device is then also usable for the intended purpose, or whether for example another device would have to be procured.

As an alternative or in addition, provision may be made for example for different devices to be assessed on the basis of the behavior prediction, with an analysis in turn then taking place as to which of the devices is best suited for the specified intended purpose.

It has also proved to be advantageous for a maintenance operation and/or a maintenance interval for the device to be suggested on the basis of the behavior prediction. In embodiments, it is thus possible to identify appropriate maintenance operations for the device and suggest them for example to a user. This makes it possible to prevent the device from failing, or the maintenance operation may improve safety for people.

It is likewise advantageous for replacement of the device to be suggested on the basis of the behavior prediction. If for example it is identified that the device may fail in the near future, then a replacement may be initiated, meaning that for example ordering procedures are able to be performed early and only a short downtime during the replacement will be experienced. Corresponding downtimes are thus able to be shortened.

In embodiments, the presented method is in particular a computer-implemented method. Therefore, a further aspect of embodiments of the invention relates to a computer program product containing program code means that cause an electronic computing device to perform a method according to the preceding aspect when the program code means are executed by the electronic computing device.

Embodiments of the invention furthermore also relate to a computer-readable storage medium containing a computer program product according to the preceding aspect.

Yet another aspect of embodiments of the invention relates to an electronic computing device for generating a behavior prediction for a device, having at least one recording device and a further recording device, wherein the electronic computing device is designed to perform a method according to the preceding aspect. In embodiments, the method is performed by way of the electronic computing device.

Embodiments of the method should be regarded as embodiments of the computer program product, of the computer-readable storage medium and of the electronic computing device. For this purpose, the electronic computing device has in particular concrete features in order to be able to perform corresponding method steps.

A computing unit/electronic computing device may be understood to mean in particular a data processing device containing a processing circuit. The computing unit may thus in particular process data in order to perform computing operations. This may possibly also include operations for performing indexed access operations to a data structure, for example a look-up table (LUT).

The computing unit may in particular contain one or more computers, one or more microcontrollers and/or one or more integrated circuits, for example one or more application-specific integrated circuits (ASIC), one or more field-programmable gate arrays (FPGA), and/or one or more systems-on-a-chip (SoC). The computing unit may also contain one or more processors, for example one or more microprocessors, one or more central processing units (CPU), one or more graphics processing units (GPU) and/or one or more signal processors, in particular one or more digital signal processors (DSP). The computing unit may also contain a physical or virtual group of computers or other ones of the stated units.

In various exemplary embodiments, the computing unit contains one or more hardware and/or software interfaces and/or one or more memory units.

A memory unit may be designed as a volatile data memory, for example as a dynamic random access memory (DRAM) or a static random access memory (SRAM), or as a non-volatile data memory, for example as a read-only memory (ROM), as a programmable read-only memory (PROM), as an erasable programmable read-only memory (EPROM), as an electrically erasable programmable read-only memory (EEPROM), as a flash memory or flash EEPROM, as a ferroelectric random access memory (FRAM), as a magnetoresistive random access memory (MRAM) or as a phase-change random access memory (PCRAM).

A surroundings sensor system/recording device may be understood for example as a sensor system capable of generating sensor data or sensor signals that reproduce, represent or replicate an environment of the surroundings sensor system. In embodiments, the ability to capture electromagnetic or other signals from the environment is not sufficient to consider a sensor system to be a surroundings sensor system. By way of example, cameras, radar systems, lidar systems, temperature sensors, humidity sensors, light sensors, voltage sensors or ultrasonic sensor systems may be understood to be surroundings sensor systems.

For application cases or application situations that may arise in embodiments of the method and that are not described explicitly here, provision may be made, according to embodiments of the method, for an error message and/or a request for input of user feedback to be output and/or a default setting and/or a predetermined initial state to be set.

Irrespective of the grammatical gender of a specific term, persons with male, female or other gender identity are also included.

Further features of embodiments of the invention will become apparent from the claims, the figures and the description of the figures. The features and combinations of features cited above in the description and the features and combinations of features cited below in the description of the figures and/or shown in the figures may be encompassed by embodiments of the invention not just in the respectively specified combination, but also in other combinations. The invention may in particular also encompass embodiments and combinations of features that do not contain all of the features of a claim as originally worded. The invention may moreover encompass embodiments and combinations of features that go beyond or deviate from the combinations of features set out in the back-references in the claims.

### BRIEF DESCRIPTION

Some of the embodiments will be described in detail, with references to the following Figures, wherein like designations denote like members, wherein:

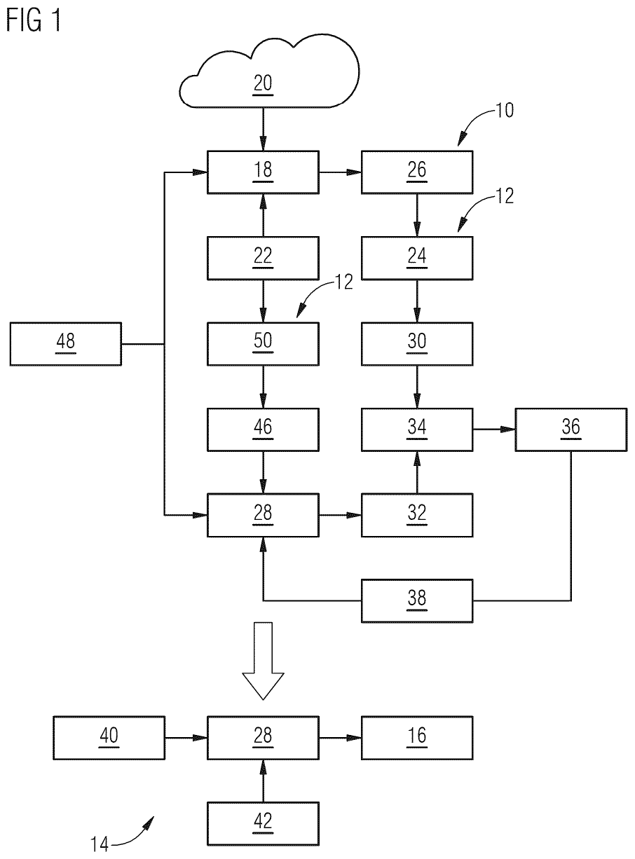

FIG. 1 shows a schematic flowchart according to an embodiment of the method;

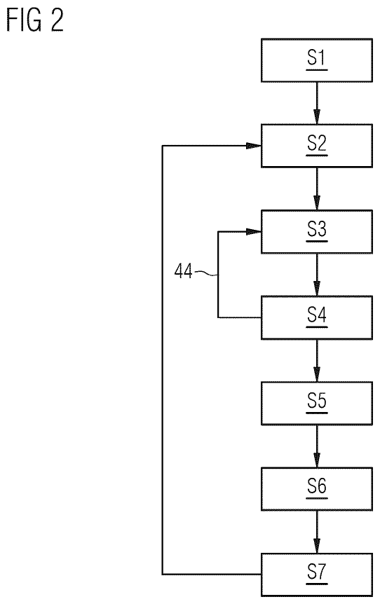

FIG. 2 shows another schematic flowchart according to an embodiment of the method; and

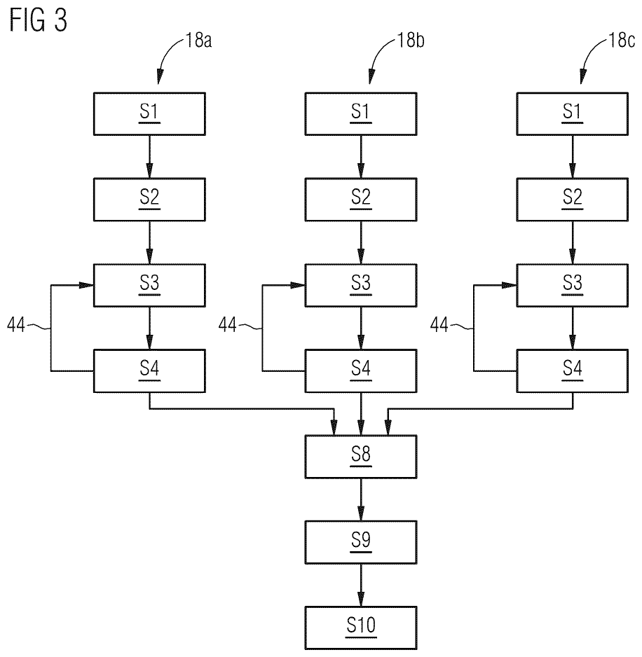

FIG. 3 shows yet another schematic flowchart according to an embodiment of the method.

### DETAILED DESCRIPTION

The invention will be explained in more detail below with reference to specific exemplary embodiments and associated schematic drawings. In the figures, identical or functionally identical elements may be provided with the same reference signs. The description of identical or functionally identical elements may not necessarily be repeated with regard to different figures.

FIG. 1 shows a schematic flowchart according to an embodiment of the method, in particular executed with an electronic computing device 10. The electronic computing device 10 has at least one recording device 12 and a further recording device 14. The electronic computing device 10 may be used in particular to generate a behavior prediction 16 for a device 18.

FIG. 1 shows in particular that the device 18 may be influenced by indeterminate influences 20 and by environmental influences 22. The environmental influences 22 may in particular for example be recorded by way of the recording device 12; in particular, a behavior parameter 24 may be recorded. The behavior parameter 24 is in particular recorded on the basis of a behavior 26 of the device 18 during actual operation. Furthermore, provision may be made for corresponding control inputs 48, which are likewise transmitted to the device 18.

A behavioral model 28 is also shown in the present exemplary embodiment. The behavioral model 28 also experiences the corresponding control inputs 48 and the measured environmental influences 46. In particular, FIG. 1 shows a measurement 50 for this purpose. The behavioral model 28 is in particular a jointly learning behavioral doppelganger for the corresponding device 18. The behavioral model 28 may be provided in particular as a neural network, for example as a reinforcement learning neural network.

FIG. 1 furthermore shows that a corresponding response 30 is able to be recorded on the basis of the behavior 26. The behavioral model 28 may be used in particular to predict a predicted effect 32. The response 30 may be compared with the predicted effect 32 in a comparison 34. A corresponding match 36 or else a deviation may then in turn be fed back to the behavioral model 28 as what is referred to as reinforcement learning 38.

In embodiments, a simulation parameter 40, 42 may be recorded by way of the further recording device 14. The simulation parameter 40, 42 may be recorded for example as a control parameter 40 and/or as an environmental parameter 42.

FIG. 1 in particular shows that the physical device 18 is complemented with the behavioral model 28. During operation of the device 18, the behavioral model 28 learns the current behavior 26 of the device 18. If external influences lead to a change in the behavior 26, the behavioral model 28 adapts thereto with a short delay, in particular learns alongside. The behavioral model 28 is used for decision-making. The expected behavior 26 of the device 18 is predicted or simulated on the basis of the currently learned behavior 26.

In embodiments, a copy/snapshot of the behavioral model 28 may be generated in order to perform the simulation. In embodiments, a behavioral model 28 is thus trained during operation and, for example, the simulation may be performed with the copy. In embodiments, the two behavioral models 28 may be provided on different computing instances. The simulation is thus not generally performed in the operating environment and is therefore also not restricted by the scarcity of resources that may be prevalent there.

The behavioral model 28 here adapts continuously to the actual behavior 26 of the device 18. This is achieved for example by measuring the observable or measurable influences and control inputs 48. Unobservable or unmeasurable influences, in particular the indeterminate influences 20, that were previously lost for predictions are learned by the behavioral model 28 through their effects. The behavioral model 28 makes a prediction regarding the expected response 30 of the device 18 to these control inputs 48. The actual response 30 of the device 18 to these inputs, which corresponds in particular to the actual behavior 26, is observed and measured. The observed behavior 26 results from the observable and measurable influences or inputs, the unobservable or unmeasurable influences and the current state of the device 18. The prediction quality is determined by comparing 34 the predicted and actual behavior 26. The behavioral model 28 is then trained by the feedback, for example the prediction deviation.

The lower part of FIG. 1 then in turn in particular shows the behavior prediction 16. The behavioral model 28 receives the expected measurable influences and control parameters 14 in the expected chronological sequence as inputs. The behavioral model 28 makes the behavior prediction 16 regarding the expected response 30 of the device 18 to the inputs and influences over time, based on the current learning state of the behavioral model 28. The behavior prediction 26 may then be used for decision-making.

FIG. 2 shows another schematic flowchart according to an embodiment of the method. FIG. 2 shows one exemplary application of an exemplary embodiment, for example a drive system. In the exemplary embodiment, it may be discussed for example whether a tunnel boring machine is still suitable for a corresponding construction project.

The tunnel boring machine corresponds here to the device 18. The device 18 here has for example a drive having a converter. Commissioning takes place in the first step S1. Provision is made here to operate the drive under various typical operating/load scenarios with different environmental conditions. Observation is carried out on device parts, for example control inputs on the converter, such as for example a target speed, environmental influences such as temperature, humidity or mechanical resistance, along with responses, in particular responses of the drive to these parameters, for example a speed profile, torque profile, temperature profile, vibration or sound. These data may then in turn be used to train the behavioral model 28.

The second step S2 describes that the device 18 is used as intended, for example to drive the tunnel boring machine.

The third step S3 is again during operation of the device 18. The behavior of the device 18 changes here. Known variables, for example operating time and temperature and humidity, along with indeterminable ones, for example properties of the bored material, wear and soiling, are corresponding factors here.

In the fourth step S4, the behavioral model 28 is adapted to the changed behavior 26 of the real device 18. An arrow 44 shows in particular that steps S3 and S4 are performed continuously over the lifetime of the real device 18.

A fifth step S5 shows a special situation; for example, the bore may encounter a particularly hard material. A decision needs to be made as to whether the device 18 is able to cope with this. A copy of the behavioral model 28 is then created, which is then in turn able to perform the simulation.

In the sixth step S6, the behavioral model 28 is simulated with the influences from the special situation in order to predict the expected behavior of the real device 18. The expected behavior in the boring simulation is replaced by the behavior of the behavioral model 28 and the observation of the simulated behavior 26.

In a seventh step S7, the decision regarding an appropriate response 30 may in turn be made for the real device 18, for example as to whether the hard material should be blasted or early maintenance or the operation of the device 18 should be continued. From the seventh step S7, it is again possible to jump to the second step S2.

FIG. 3 shows another schematic flowchart according to an embodiment of the method. FIG. 3 in particular shows that for example, for a specific project, three different devices 18a, 18b, 18c need to be assessed as to which of the devices 18a, 18b, 18c is better suited for this project. Steps S1 to S4 are the same as in FIG. 2.

The fourth step S4 is in turn followed by an eighth step S8 in which a decision needs to be made as to which device 18a, 18b, 18c from the selection of devices 18a, 18b, 18c best meets the requirements for the application case. In this case, corresponding behavioral models 28 of other devices that come into consideration and that have been operated under similar conditions may in turn then be created.

In the ninth step S9, a simulation is in turn carried out, wherein the behavioral model 28 is stimulated with influences from expected special situations in order to predict the expected behavior of the real device 18a, 18b, 18c. The expected behavior in the boring machine simulation is replaced by the behavior of the behavioral models 28 and the observation of the simulated behavior.

In the tenth step S10, the decision may then in turn be made as to which devices 18a, 18b, 18c come into consideration and a risk assessment may be performed as to whether there may be a need for a new boring machine.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for generating a behavior prediction for a device by way of an electronic computing device, the method comprising:
providing an initial model of the device by way of the electronic computing device;
recording at least one behavior parameter currently characterizing the device by way of a recording device of the electronic computing device;
adapting the initial model, on a basis of the recorded behavior parameter, so as to form a behavioral model of the device by way of the electronic computing device;
recording a simulation parameter for the device by way of a further recording device of the electronic computing device;
assessing the behavioral model on a basis of the simulation parameter by way of the electronic computing device; and
generating the behavior prediction on a basis of an evaluation by way of the electronic computing device.

2. The method as claimed in claim 1, wherein the at least one behavior parameter is recorded continuously and the behavioral model is adapted continuously.

3. The method as claimed in claim 1, wherein
the generated behavior prediction is compared with an actual behavior of the device and the behavioral model is adapted on a basis of a comparison.

4. The method as claimed in claim 1, wherein a control parameter for the device is recorded as simulation parameter.

5. The method as claimed in claim 1, wherein an environmental parameter for the device is recorded as simulation parameter.

6. The method as claimed in claim 1, wherein the electronic computing device is provided with a neural network.

7. The method as claimed in claim 6, wherein the neural network is provided for reinforcement learning.

8. The method as claimed in claim 1, wherein an actual behavior of the device is recorded as behavior parameter.

9. The method as claimed in claim 1, wherein current environmental conditions are recorded at the device and taken into account when adapting the behavioral model.

10. The method as claimed in claim 1, wherein a usability of the device for a specific intended purpose is assessed on a basis of the behavior prediction.

11. The method as claimed in claim 1, wherein a maintenance operation and/or a maintenance interval for the device is suggested on a basis of the behavior prediction.

12. The method as claimed in claim 1, wherein replacement of the device is suggested on a basis of the behavior prediction.

13. A computer program product, comprising a computer readable hardware storage device having computer readable program code stored therein, said program code executable by a processor of a computer system to implement a method as claimed in claim 1 when the program code means are executed by the electronic computing device.

14. A computer-readable storage medium comprising a computer program product as claimed in claim 13.

15. An electronic computing device for generating a behavior prediction for a device, having at least one recording device and a further recording device, wherein the electronic computing device is configured to perform a method as claimed in claim 1.
